(19) United States
(12) Patent Application Publication
(10) Pub. No.: US 2010/0005502 A1
(43) Pub. Date: Jan. 7, 2010

(54) DIGITAL BROADCAST RECEIVING APPARATUS AND CONTROL METHOD AND PROGRAM FOR THE SAME

(75) Inventor: Katsuyuki Onozawa, Kawasaki-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/480,878

(22) Filed: Jun. 9, 2009

(30) Foreign Application Priority Data
Jul. 1, 2008 (JP) 2008-172643

(51) Int. Cl. H04N 7/173

(52) U.S. Cl. 725/133

(57) ABSTRACT

An apparatus to which an electronic device can be connected, and that acquires a program distributed by the digital broadcast signal and that runs on the electronic device, comprising an extracting unit extracting, from the digital broadcast signal, distribution schedule information pertaining to the program; a unit holding the program; an updating unit executing update processing for updating an existing program in the electronic device with the acquired program, and including a first mode in which an update processing screen is displayed on a display unit and a second mode in which an update processing screen is displayed on a display unit of the electronic device; and a unit controlling the updating unit to execute the update processing in the second mode if an image is being displayed by the displaying unit, and to execute the update processing in the first mode if an image is not being displayed.

### BACKGROUND OF THE INVENTION

1. Field of the Invention

The present invention relates to technology for downloading a program distributed along with a digital broadcast signal and performing updating with use of the program.

2. Description of the Related Art

Conventionally, technology has been proposed in which when receiving a digital broadcast signal, a digital broadcast receiving apparatus downloads the data of a program or the like that runs not only on the digital broadcast receiving apparatus, but also on a peripheral device connected thereto, after which the program is transferred to the device and program updating is performed.

Such technology is disclosed in, for example, Japanese Patent Laid-Open No. 2004-164235, which proposes technology in which a digital broadcast receiving apparatus receives peripheral device identification information and program data via a broadcast signal, and rewrites program data in a peripheral device based on the received identification information. Also, Japanese Patent Laid-Open No. 2003-316596 discloses technology in which a digital broadcast receiving apparatus extracts version upgrade information for a program from a broadcast signal, specifies a target peripheral device based on the version upgrade information, and performs version upgrading. Furthermore, it is disclosed that if version upgrading overlaps with the operation of a function (e.g., timer recording) in a peripheral device, the version upgrading is delayed to a free time.

However, the conventional technology described above is based on the assumption that program data that has been downloaded via a broadcast signal by a digital broadcast receiving apparatus is transferred to a peripheral device and then updating is performed. For this reason, consideration has not been given to problems that arise when a user transfers a downloaded program to a peripheral device and performs updating at an arbitrary time.

Such problems arise when a digital broadcast receiving apparatus is performing image processing such as processing for conversion to high definition on a received broadcast signal while the broadcast signal is being received, and when the digital broadcast receiving apparatus is performing processing for updating itself or a peripheral device with use of a downloaded program. In such cases, the digital broadcast receiving apparatus is subjected to an excessive processing load, which has a negative influence on image processing and the like, and a long time is required for transferring the downloaded program to the peripheral device and performing updating.

Also, if a plurality of electronic devices are connected to a digital broadcast receiving apparatus, various problems arise when downloading programs for each device and performing updating of each device with use of the downloaded programs, and the conventional technology described above does not give consideration to such problems.

Specifically, an increase in the number of electronic devices connected to a digital broadcast receiving apparatus leads to overlapping in processing for downloading programs for each device and performing updating with use of the downloaded programs for each device, as well an increase in the amount of time required for processing. This means that there is an increase in the amount of time during which the use of the digital broadcast receiving apparatus and the peripheral devices is restricted.

Also, the user cannot know when the transfer of downloaded programs and updating are to be executed. The reason for this is that these devices cannot be used during transfer and updating.

### SUMMARY OF THE INVENTION

In order to solve the aforementioned problems, the present invention provides a digital broadcast receiving apparatus to which an electronic device lacking a function for receiving a digital broadcast signal can be connected, and that acquires a program that is distributed by being multiplexed in the digital broadcast signal and that runs on the electronic device, the apparatus comprising: a receiving unit configured to receive the digital broadcast signal; an extracting unit configured to extract, from the digital broadcast signal, distribution schedule information pertaining to the program that is distributed along with the digital broadcast signal; a holding unit configured to hold the program acquired in accordance with the distribution schedule information; a displaying unit configured to display an image using a received image signal; an updating unit configured to execute update processing for updating an existing program in the electronic device with the acquired program, the update processing including a first mode in which an update processing screen is displayed on the displaying unit and a second mode in which an update processing screen is displayed on a display unit of the electronic device; and a controlling unit configured to control the updating unit to execute the update processing in the second mode if an image is being displayed by the displaying unit of the digital broadcast receiving apparatus, and to execute the update processing in the first mode if an image is not being displayed by the displaying unit.

The present invention also provides a digital broadcast receiving apparatus to which an electronic device lacking a function for receiving a digital broadcast signal can be connected, and that acquires a program that is distributed by being multiplexed in the digital broadcast signal and that runs on the electronic device, the apparatus comprises an acquiring unit configured to acquire information regarding the electronic device from the electronic device; an extracting unit configured to extract, from notice information included in the digital broadcast signal, distribution schedule information pertaining to the program that is distributed along with the digital broadcast signal; a schedule creating unit configured to create a schedule for executing processing for acquiring the program and processing for updating an existing program in the electronic device with the acquired program, based on the information regarding the electronic device and the program distribution schedule information; and a displaying unit configured to display the created schedule.

The present invention also provides a control method for a digital broadcast receiving apparatus to which an electronic device lacking a function for receiving a digital broadcast signal can be connected, and that acquires a program that is distributed by being multiplexed in the digital broadcast signal and that runs on the electronic device, the control method comprises the steps of: receiving the digital broadcast signal; extracting, from the digital broadcast signal, distribution schedule information pertaining to the program that is distributed along with the digital broadcast signal; holding the program acquired in accordance with the distribution schedule information; displaying an image using a received image signal; executing update processing for updating an existing program in the electronic device with the acquired program, the update processing including a first mode in which an update processing screen is displayed in the displaying step and a second mode in which an update processing screen is displayed on a display unit of the electronic device; and performing control so that in the updating step, the update processing is executed in the second mode if an image is being displayed in the displaying step, and the update processing is executed in the first mode if an image is not being displayed in the displaying step.

The present invention also provides a control method for a digital broadcast receiving apparatus to which an electronic device lacking a function for receiving a digital broadcast signal can be connected, and that acquires a program that is distributed by being multiplexed in the digital broadcast signal and that runs on the electronic device, the control method comprises the steps of: acquiring information regarding the electronic device from the electronic device; extracting, from notice information included in the digital broadcast signal, distribution schedule information pertaining to the program that is distributed along with the digital broadcast signal; creating a schedule for executing processing for acquiring the program and processing for updating an existing program in the electronic device with the acquired program, based on the information regarding the electronic device and the program distribution schedule information; and displaying the created schedule.

According to the present invention, by performing updating with use of a downloaded program in an electronic device while the digital broadcast receiving apparatus is operating, there is no increase in the processing load on the digital broadcast receiving apparatus, no negative influence on image processing and the like, and the transfer of the downloaded program and the updating do not require an excessive amount of time.

The present invention also enables creating a schedule such that there is no overlapping in processing for downloading programs for each electronic device and updating each electronic device with use of the downloaded programs. For this reason, even if the number of electronic devices connected to the digital broadcast receiving apparatus increases, it is possible to prevent overlapping in processing for downloading programs and updating, and prevent a lengthening of processing time.

Also, notifying a user of a schedule for transferring downloaded programs and performing updating enables the user to be aware in advance of time periods during which the use of peripheral devices is restricted. This enables the user to use a device while predicting and taking into consideration the time period during which its use is restricted, thereby making it possible to avoid a situation in which the device cannot be used when a sudden need for use arises at a certain time.

Further features of the present invention will become apparent from the following description of exemplary embodiments with reference to the attached drawings.

### BRIEF DESCRIPTION OF THE DRAWINGS

FIG. 1 is a block diagram showing an exemplary system configuration of Embodiment 1 according to the present invention.

FIG. 2 is a flowchart showing program update processing according to Embodiment 1.

FIG. 3 is a flowchart showing program update processing according to Embodiment 1.

FIG. 4 is a flowchart showing program update processing according to Embodiment 1.

FIG. 5 is a block diagram showing an exemplary system configuration of Embodiment 2 according to the present invention.

FIG. 6 is a block diagram showing an exemplary system configuration of Embodiment 3 according to the present invention.

FIG. 7 is a flowchart showing schedule creation processing and processing for downloading a program and performing updating according to Embodiment 3.

FIG. 8 is a flowchart showing schedule creation processing and processing for downloading a program and performing updating according to Embodiment 3.

FIG. 9 is a diagram showing examples of electronic devices that are connected to a digital TV.

FIG. 10 is a diagram showing an exemplary priority order that is set in the case of creating a schedule for downloading an update program and performing updating in the electronic device connection state shown in FIG. 9.

FIG. 11 is a diagram showing an exemplary display of a schedule that is displayed by the digital TV and exemplary operations of the digital TV in the connection state shown in FIG. 9.

FIG. 12 is a flowchart showing processing performed if a schedule has been changed according to Embodiment 4.

### DESCRIPTION OF THE EMBODIMENTS

Below is a detailed description of embodiments for prating the present invention with reference to the attached drawings.

It should be noted that the embodiments described below are merely examples for realizing the present invention, appropriate corrections and modifications should be made depending on various conditions and the configuration of the apparatus to which the present invention is to be applied, and furthermore the present invention is not limited to the following embodiments.

### Embodiment 1

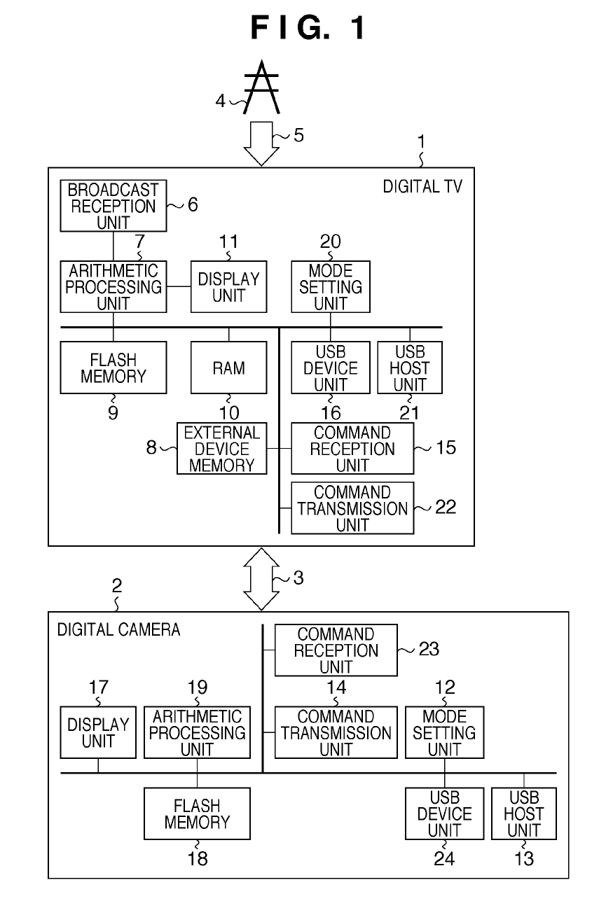

FIG. 1 is a block diagram showing an exemplary system configuration of Embodiment 1 according to the present invention.

The following describes a configuration in which a digital TV 1, which is a digital broadcast receiving apparatus, and a digital camera 2, which is an electronic device that does not have a function for receiving a digital broadcast signal (hereinafter, called a broadcast signal), are connected via a wireless USB 3.

Also, in the present embodiment, data that is downloaded by the digital TV 1 via a broadcast signal 5 is considered to be an update program for the digital camera 2.

The digital TV 1 can identify a model ID that is unique identification information for specifying the model of the digital camera 2 that is connected to the digital TV 1 via the wireless USB 3. Also, the digital TV 1 and the digital camera 2 are considered to have registered or recognized each other as connection target devices in advance.

The fact that an update program for the digital camera 2 whose model ID has been recognized is to be distributed via the broadcast signal 5 is notified by download (DL) notice information included in the broadcast signal 5 distributed from a broadcast station 4. The download notice information includes, for example, a model ID of the program to be distributed and distribution schedule information such as a download start date, start time, and duration.

If downloading at the notified distribution schedule time is possible, the digital TV 1 downloads program data via a broadcast reception unit 6. The downloaded program data is reconfigured into a single file by an arithmetic processing unit 7 and stored in an external device memory 8 of the digital TV 1. The external device memory 8 may be the same as a flash memory 9 for holding, for example, setting values of the digital TV 1, and a RAM 10 used as a work area for a program or the like in the digital TV 1.

Next, the digital TV 1 displays, on a display unit 11, the fact that an update program for the digital camera 2 has been downloaded, thereby notifying a user.

The following describes the case of updating an existing program in the digital camera 2 with use of an update program that was downloaded while the digital TV 1 was receiving the broadcast signal 5, that is to say, during the viewing of a TV program on the digital TV 1.

First, the digital camera 2 is set to a device-side update mode. Consequently, a mode setting unit 12 starts a USB host unit 13 of the digital camera 2, and simultaneously a command is transmitted from a command transmission unit 14 to the digital TV 1. Upon receiving the command via a command reception unit 15, the digital TV 1 starts a USB device unit 16 in accordance with the received command. In this way, the digital TV 1 and the digital camera 2 are connected via the wireless USB 3.

A program update menu is displayed on a display unit 17 of the digital camera 2, thereby enabling the user to perform various operations regarding program updating. When program update processing has started, the digital camera 2 compares the version of the program stored in the external device memory 8 of the digital TV 1 and the version of the program stored in a flash memory 18 of the digital camera 2. Program updating is then executed if necessary. Here, program updating is executed by an arithmetic processing unit 19 of the digital camera 2. Consequently, the program can be updated without an increase in the processing load on the arithmetic processing unit 7 of the digital TV 1, and without impeding processing for conversion to high definition or the like that is performed in the digital TV 1 during reception of a broadcast signal. Also, since the menu required for the user to perform operations is displayed on the digital camera 2, the viewing of a TV program is not impeded either.

The following describes the case in which the user arbitrarily updates a program in the digital camera 2 while a TV program is not being viewed on the digital TV 1.

In the case of updating a program in the digital camera 2 while a TV program is not being viewed on the digital TV 1, first the digital TV 1 is set to an apparatus-side update mode. Consequently, a mode setting unit 20 starts a USB host unit 21 of the digital TV 1, and simultaneously a command is transmitted from a command transmission unit 22 to the digital camera 2. Upon receiving the command via a command reception unit 23, the digital camera 2 starts a USB device unit 24 in accordance with the received command. In this way, the digital TV 1 and the digital camera 2 are connected via the wireless USB 3.

A program update menu for the digital camera 2 is displayed on the display unit 11 of the digital TV 1, thereby enabling the user to perform operations regarding program updating. When program update processing has started, the digital TV 1 compares the version of the program stored in the external device memory 8 and the version of the program stored in the flash memory 18 of the digital camera 2. Program updating is then executed if necessary. Here, the program updating is executed by the arithmetic processing unit 7 of the digital TV 1. In this way, the arithmetic processing unit 19 of the digital camera 2 is not used, thereby suppressing the power consumption of the digital camera 2 and preventing battery depletion.

Control Flow

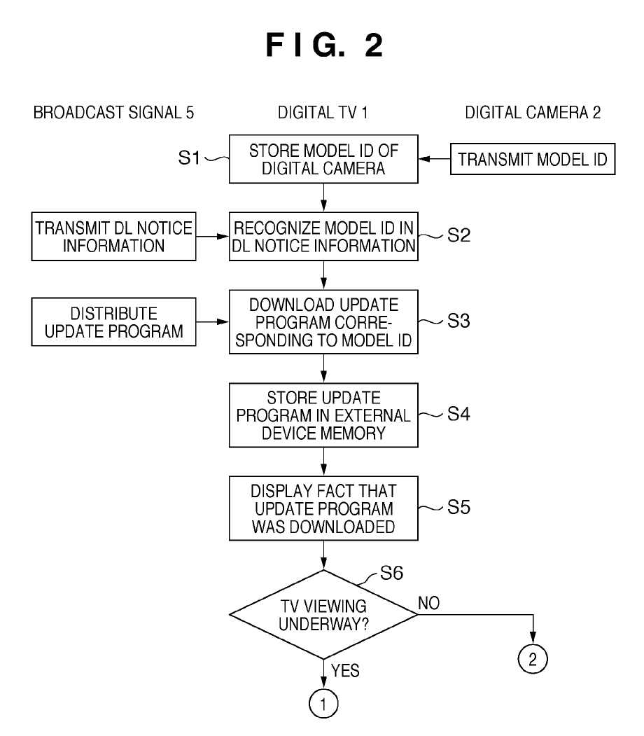

FIGS. 2 to 4 are flowcharts showing program update processing according to the present embodiment.

In FIG. 2, the digital TV 1 identifies the model ID for specifying the model of the digital camera 2 that is to be connected thereto via the wireless USB 3, registers or recognizes the digital camera 2 as a connection target device in advance, and stores the model ID (S1).

Next, the fact that an update program for the digital camera 2 whose model ID was stored in S1 is to be distributed via the broadcast signal 5 is notified by download (DL) notice information included in the broadcast signal 5 distributed from a broadcast station (S2).

The digital TV 1 downloads the update program at the notified distribution schedule time (S3). The downloaded update program is stored in the external device memory 8 of the digital TV 1 (S4).

Also, the fact that the update program has been downloaded is displayed on the display unit 11 of the digital TV 1, thereby notifying the user (S5). Here, the message that is displayed is, for example, “TV program being viewed. Perform operations with camera.” Or “Set TV to update mode.”

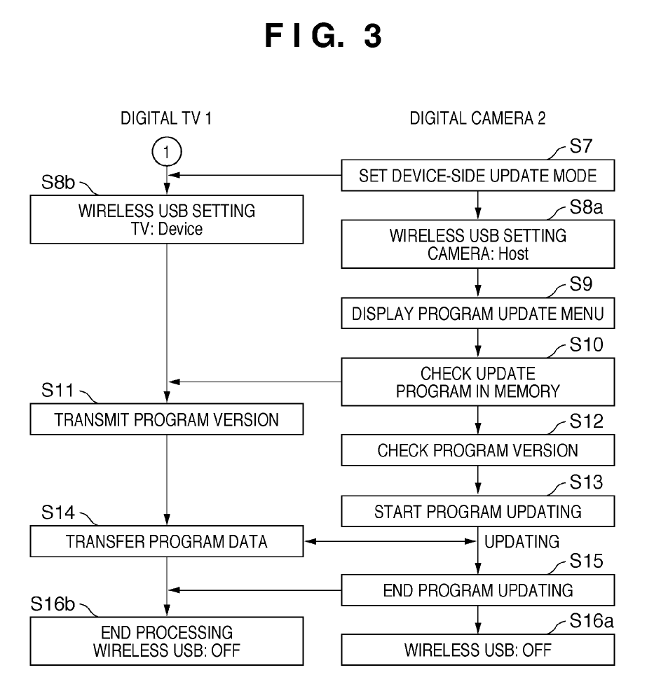

The program update processing is switched according to the operating state of the digital TV 1 (S6). Specifically, if program update processing is to be executed during the viewing of a TV program on the digital TV 1, the digital camera 2 is set to the device-side update mode as shown in FIG. 3 (S7).

When the digital camera 2 has been set to the device-side update mode, the USB host unit 13 of the digital camera 2 is started, and simultaneously a command is transmitted to the digital TV 1. Upon receiving the command, the digital TV 1 starts the USB device unit 16 in accordance with the received command (S8a and S8b).

In this way, the digital TV 1 and the digital camera 2 are connected via the wireless USB 3. Here, a program update menu is displayed on the display unit 17 of the digital camera 2 (S9), thereby enabling the user to perform operations regarding program updating.

When program update processing has started, the digital camera 2 checks the version of the program stored in the external device memory 8 of the digital TV 1 (S10). Specifically, the digital camera 2 compares the version of the program transmitted from the digital TV 1 and the version of the program in the flash memory 18 of the digital camera 2 (S11 and S12).

The digital camera 2 determines that program updating is necessary if the version of the program in the digital TV 1 is an upgraded version. Then, program update processing is executed with use of the program data transferred from the digital TV 1 (S13 and S14). When program update processing performed by the digital camera 2 has ended, end processing is executed to stop the USB device unit 16 (S15, S16a, and S16b).

In this way, program update processing is executed by the digital camera 2 if a TV program is being viewed, as a result of which there is no increase in the processing load on the digital TV 1, and processing for conversion to high definition and the like that is performed by the digital TV 1 is not impeded. Also, since the menu required for the user to perform operations is displayed on the digital camera 2, the viewing of a TV program is not impeded either.

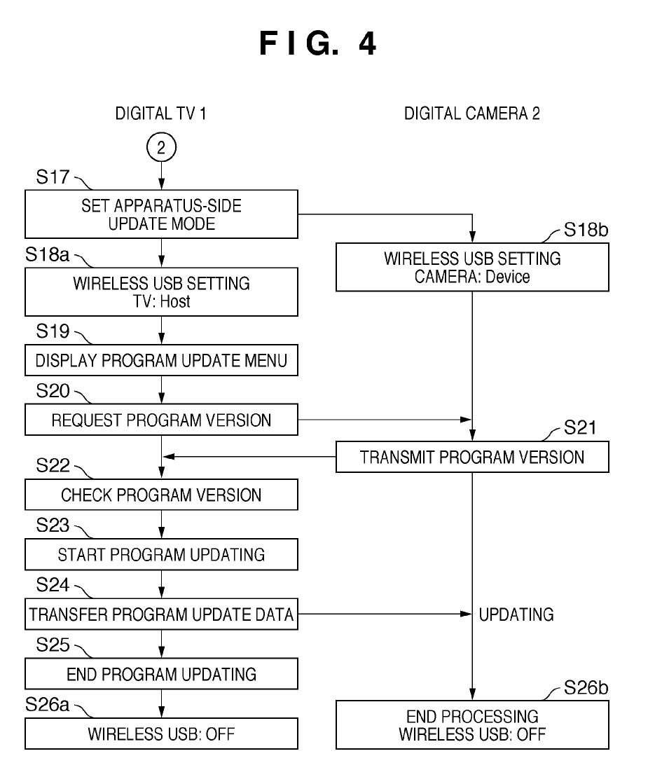

On the other hand, in the case of performing processing for updating the program in the digital camera 2 while a TV program is not being viewed on the digital TV 1 (S6), the digital TV 1 is set to the apparatus-side update mode as shown in FIG. 4 (S17).

When the digital TV 1 has been set to the apparatus-side update mode, the USB host unit 21 of the digital TV 1 is started, and simultaneously a command is transmitted to the digital camera 2. Upon receiving the command, the digital camera 2 starts the USB device unit 24 in accordance with the received command (S18a and S18b).

In this way, the digital TV 1 and the digital camera 2 are connected via the wireless USB 3. Here, a program update menu is displayed on the display unit 11 of the digital TV 1 (S19), thereby enabling the user to perform various operations regarding program updating.

When program update processing has been started, the digital TV 1 requests the transmission of the version of the program stored in the flash memory 18 of the digital camera 2 (S20). The digital TV 1 then compares the version of the program stored in the external device memory 8 and the program version transmitted from the digital camera 2 (S21 and S22).

Then, upon determining that updating of the program in the digital camera 2 is necessary, the digital TV 1 transfers program update data to the digital camera 2 and executes program update processing (S23 and S24). Here, program update processing is executed by the digital TV 1 (S24). When program update processing executed by the digital TV 1 has ended (S25), end processing is executed (S26a and S26b).

In this way, if a TV program is not being viewed, the digital TV 1 executes program update processing, thereby suppressing power consumption in the digital camera 2 and preventing battery depletion.

It should be noted that although an update program for an electronic device such as the digital camera 2 is described as an example of data received via the broadcast signal 5 in the present embodiment, the present invention can also be realized in the case of other data such as image data. Also, although a configuration, series of operations, and settings are described based on the assumption of a connection by wireless USB in the present embodiment, the present invention is not limited to wireless connection, but rather a similar configuration and similar operations and settings are possible in the case of a wired USB connection, and the same effects can be achieved. Furthermore, the present invention is not limited to connection by USB, but rather the present invention can also be realized in the case of using a connection method such as HDMI or IEEE 1394 that are used for inter-device connection, and the same effects can be achieved.

### Embodiment 2

The following describes, as Embodiment 2, the case in which the digital TV 1 and the digital camera 2 are connected via the wireless USB 3, and furthermore a digital video camera 26, which is an electronic device, is connected to the digital TV 1 via an HDMI unit 25.

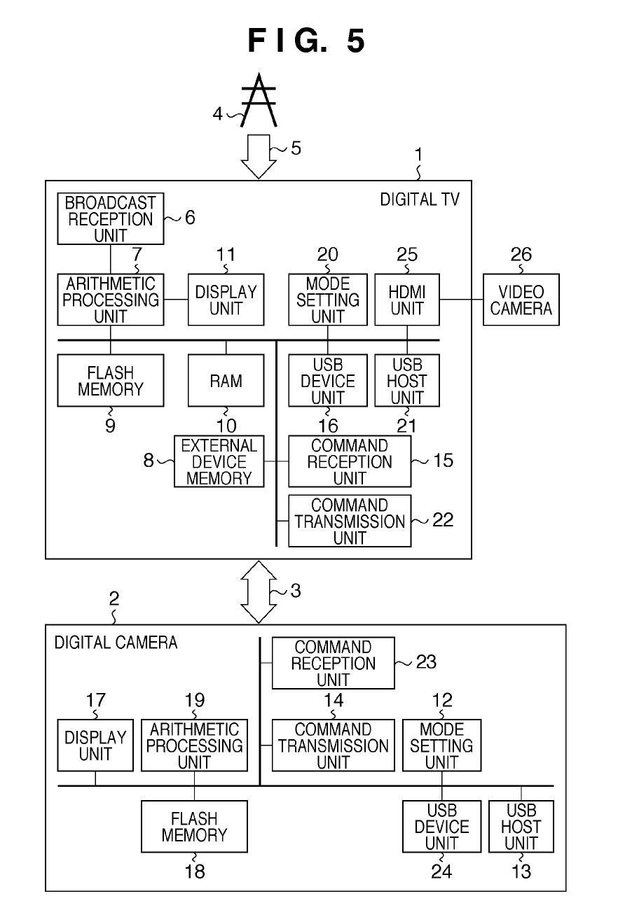

FIG. 5 is a block diagram showing an exemplary system configuration of Embodiment 2 according to the present invention.

It should be noted that in the following, the same reference numbers have been given to constituent elements that are the same as in FIG. 1, and redundant descriptions of series of operations and settings have been omitted.

Also, in the present embodiment, data that is downloaded by the digital TV 1 via the broadcast signal 5 is considered to be an update program for the digital camera 2 and an update program for the video camera 26.

In FIG. 5, the digital TV 1 can identify model IDs for specifying the models of the digital camera 2 and the video camera 26. Also, the digital TV 1 and the digital camera 2 or the video camera 26 are considered to have registered or recognized each other as connection target devices in advance.

Here, if processing for updating a program in the digital camera 2 is to be executed while the digital TV 1 is executing processing for updating a program in the video camera 26 via the HDMI unit 25, the digital camera 2 is set to the device-side update mode. Consequently, the mode setting unit 12 starts the USB host unit 13 of the digital camera 2, and simultaneously a command is transmitted from the command transmission unit 14 to the digital TV 1. Upon receiving the command via the command reception unit 15, the digital TV 1 starts the USB device unit 16 in accordance with the received command. In this way, the digital TV 1 and the digital camera 2 are connected via the wireless USB 3.

A program update menu is displayed on the display unit 17 of the digital camera 2, thereby enabling the user to perform various operations regarding program updating. When program update processing has started, the digital camera 2 compares the version of the program stored in the external device memory 8 of the digital TV 1 and the version of the program stored in the flash memory 18 of the digital camera 2. Program updating is then executed if necessary. Here, program updating is executed by the arithmetic processing unit 19 of the digital camera 2. Consequently, the programs in both the digital camera 2 and the video camera 26 can be updated without an increase in the processing load on the arithmetic processing unit 7 of the digital TV 1, and without impeding processing for updating the program in the video camera 26 via the HDMI unit 25. Also, since the menu required for the user to perform operations is displayed on the digital camera 2, program update processing for each device can be executed without displaying a plurality of different program update menus on the digital TV 1.

It should be noted that although a configuration, series of operations, and settings are described based on the assumption of a connection by wireless USB and HDMI in the present embodiment, the present invention is not limited to wireless connection, but rather a similar configuration and similar operations and settings are possible in the case of a wired USB connection, and the same effects can be achieved. Also, the present invention is not limited to connection by a combination of USB and HDMI, but rather the present invention can also be realized in the case of using a connection method such as a combination of HDMI and IEEE 1394 that are used for inter-device connection, and the same effects can be achieved.

### Embodiment 3

The following describes, as Embodiment 3, the case of creating a schedule for the execution of processing in which the digital TV 1 downloads an update program for the digital camera 2 via the broadcast signal 5, and processing in which a program in the digital camera 2 is updated.

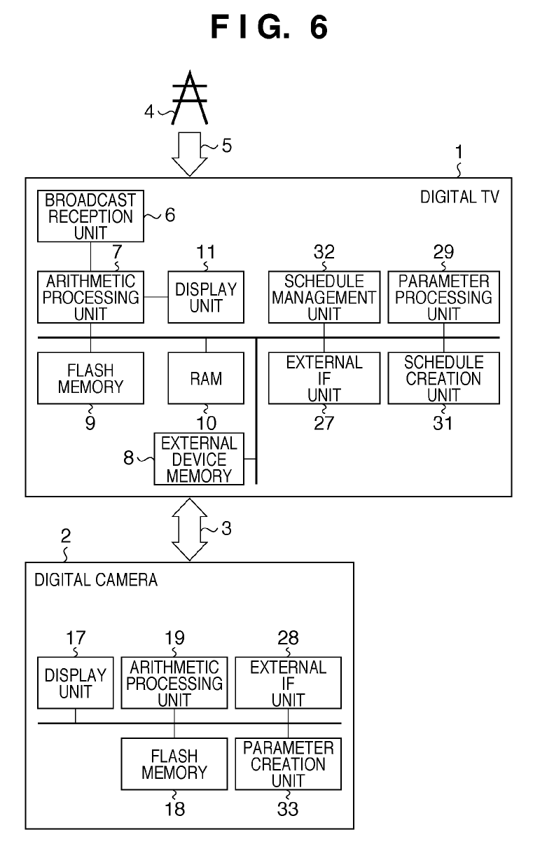

FIG. 6 is a block diagram showing an exemplary system configuration of Embodiment 3 according to the present invention.

It should be noted that in the following, the same reference numbers have been given to constituent elements that are the same as in FIG. 1, and redundant descriptions of series of operations and settings have been omitted.

Also, in the present embodiment, data that is downloaded by the digital TV 1 via the broadcast signal 5 is considered to be an update program for the digital camera 2 and an update program for the video camera 26.

In FIG. 6, the digital TV 1 can identify the model ID for specifying the model of the digital camera 2 that is connected thereto via the wireless USB 3. Also, the digital TV 1 and the digital camera 2 are considered to have registered or recognized each other as connection target devices in advance.

The fact that an update program for the digital camera 2 whose model ID has been recognized is to be distributed via the broadcast signal 5 is notified by download notice information included in the broadcast signal 5 distributed from the broadcast station 4. The digital TV 1 receives the download notice information via the broadcast reception unit 6.

In the digital TV 1, the arithmetic processing unit 7 and a parameter processing unit 29 extract, from the download notice information, information regarding the downloading of update programs for the digital TV 1 and the digital camera 2 that has been recognized. The information regarding downloading includes, for example, download start date information, start time information, and information such as a duration and an urgency.

Also, the digital TV 1 transmits, to the digital camera 2, a command for checking the connection state, state of use, and mode setting for the digital TV 1 and the digital camera 2 that have been notified by the download notice information. Upon receiving the command from the digital TV 1, the digital camera 2 creates and transmits information in accordance with the command with use of the arithmetic processing unit 19 and a parameter creation unit 33. Here, the exchange of information between the digital TV 1 and the digital camera 2 is performed over the wireless USB 3 via external IF units 27 and 28. Parameters in the information received from the digital camera 2 are processed by the parameter processing unit 29. In the digital TV 1, a schedule creation unit 31 creates a schedule for downloading an update program and performing updating in accordance with a predetermined algorithm, with use of information resulting from the processing performed by the parameter processing unit 29. This schedule is created such that update program transfer processing and update processing do not overlap between the digital TV 1 and the digital camera 2. This schedule can also be displayed on the display unit 11 of the digital TV 1 to alert the user of the schedule.

This enables the user to be aware in advance of time periods during which the use of electronic devices is restricted, as a result of which the user can use the devices while predicting and taking into consideration the time periods during which their use is restricted. This makes it possible to avoid a situation in which the devices cannot be used when a sudden need for use arises at a certain time.

In the digital TV 1, the broadcast reception unit 6 downloads the update program at the distribution schedule time in accordance with the created schedule. The external device memory 8 may be the same as a flash memory 9 for holding, for example, setting values of the digital TV 1, and a RAM 10 used as a work area for a program or the like in the digital TV 1.

The digital TV 1 transfers the downloaded program to the digital camera 2 and executes updating in accordance with the schedule that has been created in advance. During the execution of the program update processing, the digital camera 2 alerts the user that program update processing is being executed by a display on the display unit 11. The digital camera 2 expands the update program to the flash memory 18 and performs program updating. By creating a schedule for downloading an update program and performing updating, program transferring processing and update processing do not overlap between the digital TV 1 and the digital camera 2, and processing that takes the state and mode of the digital TV 1 and the digital camera 2 into consideration can be executed. The same effects are also achieved even if a plurality of electronic devices is connected to the digital TV 1. A schedule that has been created is changed if the download notice information has been updated or the state or mode of the digital TV 1 or the digital camera 2 has changed.

The digital TV 1 and the digital camera 2 exchange the changed parameters via the external IF units 27 and 28. In the digital TV 1, the changed parameters are processed by the parameter processing unit 29, and a schedule management unit 32 changes the schedule that has already been created. The user is informed of the changed schedule on a case-by-case basis by displaying the changed schedule on the display unit 11 of the digital TV 1. In this way, even if the state of the digital TV 1 or the digital camera 2 has changed, the schedule is changed accordingly and the user is alerted, thereby enabling the user to be aware of the most up-to-date schedule.

It should be noted that although an update program for an electronic device such as the digital camera 2 is described as an example of data received via the broadcast signal 5 in the present embodiment, the present invention can also be realized in the case of other data such as image data.

Also, although a configuration, series of operations, and settings are described based on the assumption of a connection by wireless USB in the present embodiment, the present invention is not limited to wireless connection, but rather a similar configuration and similar operations and settings are possible in the case of a wired USB connection, and the same effects can be achieved. Furthermore, the present invention is not limited to connection by USB, but rather the present invention can also be realized in the case of using a connection method such as HDMI or IEEE 1394 that are used for inter-device connection, and the same effects can be achieved.

Control flow

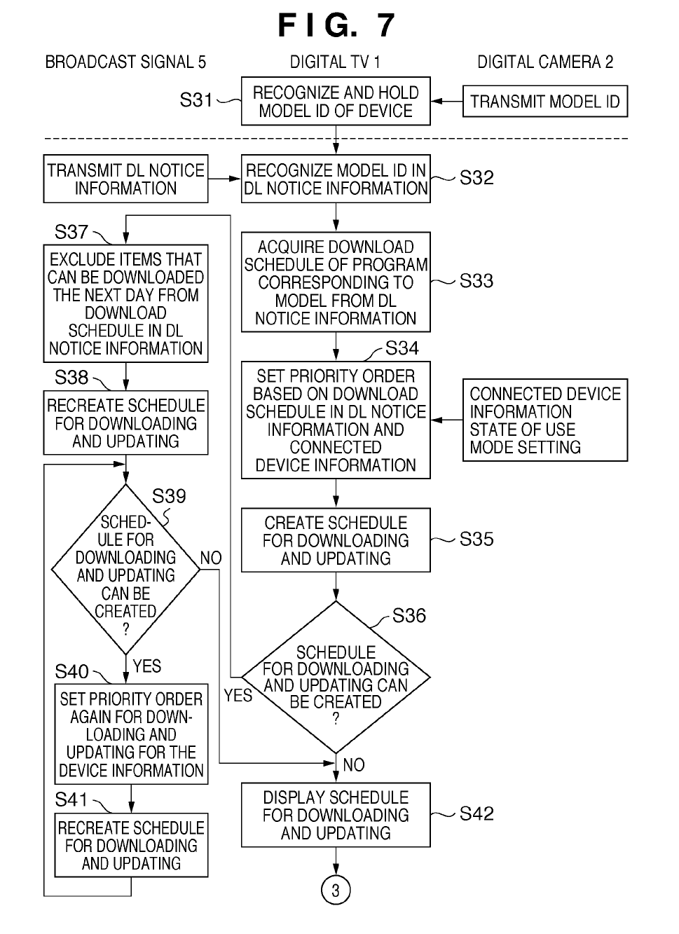

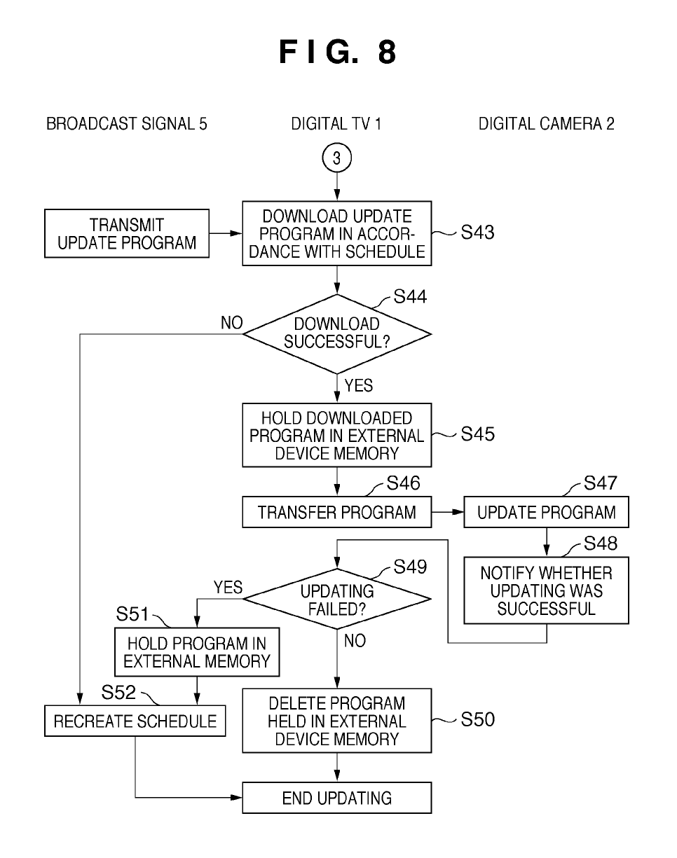

FIGS. 7 and 8 are flowcharts showing schedule creation processing and processing for downloading a program and performing updating according to the present embodiment.

In FIG. 7, the digital TV 1 identifies the model ID for specifying the model of the digital camera 2 that is to be connected thereto via the wireless USB 3, registers or recognizes the digital camera 2 as a connection target device in advance, and stores the model ID (S31).

Next, the fact that an update program for the digital camera 2 whose model ID was stored in S31 is to be distributed via the broadcast signal 5 is notified by download notice information included in the broadcast signal 5 (S32).

The digital TV 1 acquires a download schedule (distribution schedule information) for programs for the digital TV 1 and the digital camera 2 that is included in the download notice information (S33).

The digital TV 1 then transmits, to the digital camera 2, a command for checking connected device information and the state of use and mode setting (hereinafter, called device information) of the digital camera 2. Here, the connected device information includes information indicating, for example, a fixed device (constant connection) or a mobile device (as-needed connection), connectability, and a device-side state (timer recording). Upon receiving the command from the digital TV 1, the digital camera 2 creates and transmits information in accordance with the command with use of the arithmetic processing unit 19 and the parameter creation unit 33. The digital TV 1 sets a priority order for the download schedule acquired in S33 and the device information acquired from the digital camera 2 (S34).

The schedule creation unit 31 of the digital TV 1 creates a schedule in accordance with a predetermined algorithm, based on the download schedule and the device information. Here, the schedule is created such that program transfer processing and update processing do not overlap between the digital TV 1 and the digital camera 2 (S35).

Also, if it is impossible in S35 to create a schedule that ensures a sufficient amount of time for performing downloading and updating in view of the number of downloads and time required for updating (S36), the processing of S37 to S41 is performed.

The digital TV 1 excludes any items that can be downloaded the next day as well from the download schedule included in the download notice information (S37), and recreates a schedule for downloading and updating (S38). If it is still impossible to create a schedule that ensures a sufficient amount of time for downloading and updating even after schedule recreation (S39), the priority order is set again such that unconnected devices and devices having a low frequency of use have a lower priority (S40). Thereafter, a schedule for downloading and updating is created again (S41). The processing of S39 to S41 is repeated until a schedule can be created.

The schedule created in this way can be displayed on the display unit 11 of the digital TV 1 (S42), thereby informing the user of the schedule. This enables the user to be aware in advance of time periods during which the use of devices is restricted, and use the devices while predicting and taking into consideration the time periods during which their use is restricted, thereby making it possible to avoid a situation in which the devices cannot be used when a sudden need for use arises at a certain time.

The digital TV 1 downloads an update program in accordance with the created schedule (S43). The digital TV 1 then determines whether the update program has been downloaded in accordance with the created schedule (S44). If the downloading was successful, the downloaded program is held in the external device memory 8 (S45), and the update program is transferred to the digital camera 2 (S46).

In the digital camera 2, program update processing is executed with use of the update program that was transferred from the digital TV 1 (S47).

The digital camera 2 notifies the digital TV 1 of whether program updating was executed normally, that is to say, whether updating was successful (S48). If program updating has not failed (S49), the digital TV 1 deletes the program held in the external device memory 8 (S50). On the other hand, upon receiving from the digital camera 2 a notification that program updating has failed due to a failure in the update processing, the fact that the device is currently in use, or the like (S49), the digital TV 1 continues to hold the update program in the external device memory 8 rather than deleting it (S51).

Thereafter, the digital TV 1 again creates a schedule such that the downloading of a program whose downloading failed in S45 and the updating of a program whose updating failed in S47 are carried over to the next day (S52).

Downloading update programs and performing updating in this way enables preventing any program downloading and updating from being missed.

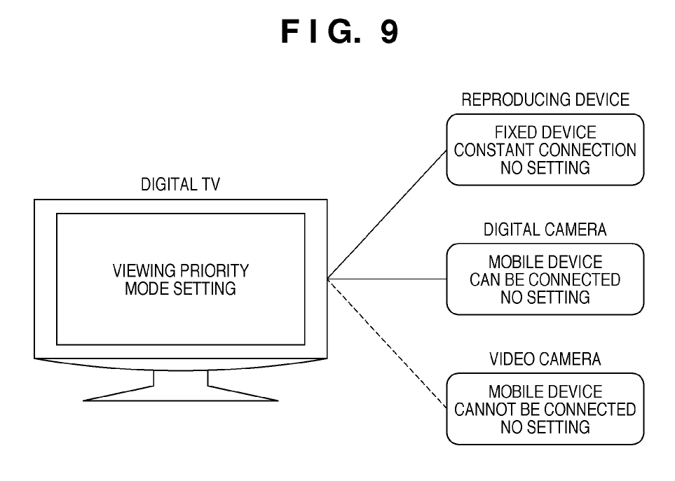

Electronic devices connected to digital TV FIG. 9 shows an example of electronic devices connected to the digital TV 1.

FIG. 9 shows a reproducing device, a digital camera, and a video camera as examples of electronic devices that can be connected to the digital TV but do not have a function for receiving a broadcast signal. The digital TV 1 has been set to a viewing priority mode such as scheduled program viewing, and the reproducing device and the digital camera are in a state of being able to connect to the digital TV. Also, the video camera has been recognized as an electronic device that can be connected to the digital TV, but is not in a state of being able to connect to the digital TV.

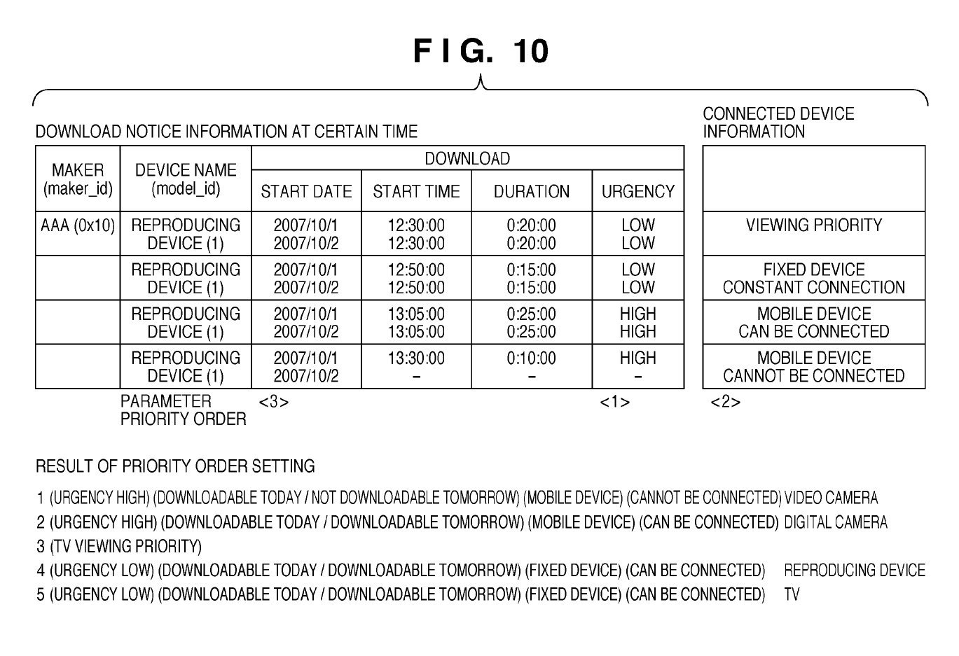

FIG. 10 shows an exemplary priority order that is set in the case of creating a schedule for downloading an update program and performing updating in the electronic device connection state shown in FIG. 9.

The digital TV extracts, from download notice information included in a broadcast signal, information for specifying an electronic device maker, information for specifying devices, and a program distribution schedule time and urgency for each device, as parameters. These parameters are used for creating a schedule, along with the connection state and mode setting of each electronic device that has been notified by the download notice information. A priority order is set for the parameters of each device. In the example shown in FIG. 10, a schedule is created such that the highest priority is set to programs that, according to the distribution schedule time, can be downloaded today and cannot be downloaded tomorrow, the next highest priority is set to the high urgency and the third highest priority is set to the viewing priority mode of the digital TV. As a result, if there is an increase in the number of electronic devices that are connected to the digital TV, update programs for the electronic devices are downloaded, and the update programs are transferred to the electronic devices and/or update processing is executed, even in this case it is possible to prevent the execution of such processing from overlapping.

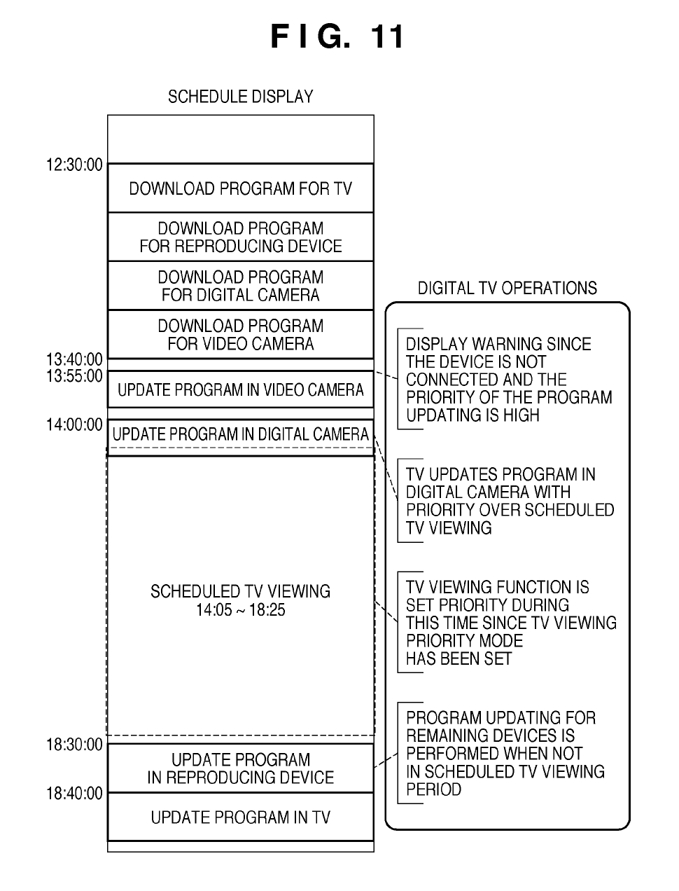

FIG. 11 shows an exemplary display of a schedule on the digital TV and exemplary operations of the digital TV in the connection state shown in FIG. 9.

In the schedule created by the digital TV, items are arranged in order from the earliest execution time, and are displayed on the digital TV along with the execution times. At each execution time, a warning is displayed if the corresponding device is not currently connected and the priority of the program update is high. Upon reaching an update start time that is before a scheduled program viewing time of the digital TV, if the digital camera program update time overlaps with the program viewing time, the fact that program update processing for the digital camera will be set high priority is displayed, and the program update processing is executed. Program update processing for other devices is executed after the scheduled program viewing time of the digital TV. This enables the user to be aware in advance of time periods during which the use of devices is restricted, and use the devices while predicting and taking into consideration the time periods during which their use is restricted, thereby making it possible to avoid a situation in which the devices cannot be used when a sudden need for use arises at a certain time.

### Embodiment 4

The following describes, as Embodiment 4, the case in which a previously created schedule is changed during the execution of program downloading and updating in accordance with the schedule.

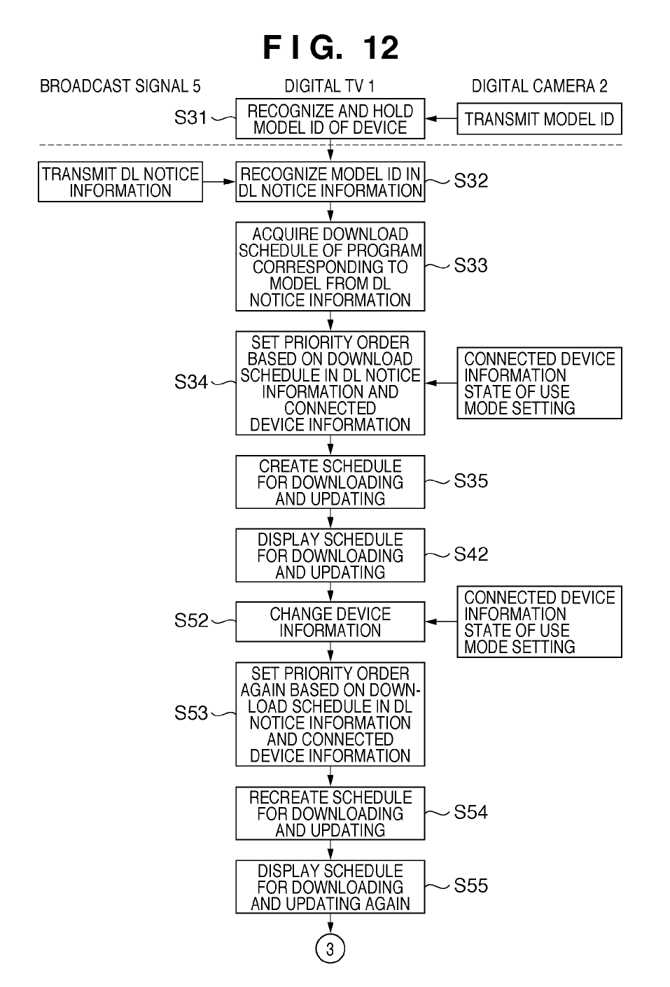

FIG. 12 is a flowchart showing operations in the case in which a previously created schedule is changed during the execution of program downloading and updating in accordance with the schedule.

It should be noted that in the following, the same reference numbers have been given to processing that is the same as in FIG. 7, and redundant descriptions have been omitted.

In FIG. 12, if device information of the digital camera 2 has changed, the digital camera 2 transmits the changed information to the digital TV 1. In accordance with the device information received from the digital camera 2, the digital TV 1 changes existing parameters regarding the digital camera 2 (S52).

Next, the digital TV 1 again sets a priority order based on the changed parameters (S53). Thereafter, a schedule for downloading and updating is created again (S54). The schedule recreated in this way can be displayed on the display unit 11 of the digital TV 1 (S55), thereby informing the user of the most up-to-date schedule.

Schedule recreation is executed not only if the digital TV 1 has received changed device information in S52, but also if download notice information included in the broadcast signal 5 has been updated, if the mode setting of the digital TV 1 has been changed, and the like.

Also, if the schedule has been recreated, the recreated most up-to-date schedule is displayed on the digital TV 1.

### Other Embodiments

The present invention also includes the case in which the present invention is achieved by directly or remotely supplying a system or an apparatus with a computer program that realizes the functionality of the embodiments described above. In this case, a computer in the system or the like reads out and executes the computer program.

Accordingly, in order to realize the functionality and processing of the present invention with the computer, the computer program itself that is installed in the computer also realizes the present invention. In this case, any mode of program, such as object code, a program executed by an interpreter, or script data supplied to an OS is acceptable, as long as the functionality of the program is provided.

Examples of a recording medium (storage medium) for supplying the program include a flexible disk, a hard disk, an optical disk, and a magneto-optical disk. Other examples include an MO, a CD-ROM, a CD-R, a CD-RW, magnetic tape, a nonvolatile memory card, a ROM, and a DVD (DVD-ROM or DVD-R).

Also, one method of supplying the program is a method of connecting to a website on the Internet using the browser of a client computer, and downloading the computer program of the present invention from the website. Alternatively, the program can be supplied by downloading a compressed file that includes an auto-install function to a recording medium such as a hard disk. Supply of the program can also be realized by splitting the computer program constituting the program of the present invention into a plurality of files and downloading the respective files from different websites. In other words, the present invention also encompasses a WWW server that allows a plurality of users to download program files for realizing the functionality and processing of the present invention with a computer.

Also, the program of the present invention can be distributed to users as an encrypted program stored on a storage medium such as a CD-ROM, and users that satisfy a predetermined condition can be allowed to download key information for performing decryption from a website via the Internet. In this case, the encrypted program is executed and installed on a computer using the downloaded key information, thereby realizing the functionality and processing of the present invention.

Also, in addition to a computer reading out and executing the program, the functionality of the embodiments described above can be realized when an OS or the like that is running on a computer performs part or all of the actual processing based on instructions in the program.

Furthermore, the functionality of the present invention can be realized when the program read out from the recording medium is written to a memory provided in a function expansion board inserted in a computer or a function expansion unit connected to a computer, and a CPU or the like provided in the function expansion board etc. performs part or all of the actual processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-172643, filed Jul. 1, 2008, which is hereby incorporated by reference herein in its entirety.

What is claimed is:

1. A digital broadcast receiving apparatus to which an electronic device lacking a function for receiving a digital broadcast signal can be connected, and that acquires a program that is distributed by being multiplexed in the digital broadcast signal and that runs on the electronic device, the apparatus comprising:
a receiving unit configured to receive the digital broadcast signal;
an extracting unit configured to extract, from the digital broadcast signal, distribution schedule information pertaining to the program that is distributed along with the digital broadcast signal;
a holding unit configured to hold the program acquired in accordance with the distribution schedule information;
a displaying unit configured to display an image using a received image signal;
an updating unit configured to execute update processing for updating an existing program in the electronic device with the acquired program, the update processing including a first mode in which an update processing screen is displayed on said displaying unit and a second mode in which an update processing screen is displayed on a display unit of the electronic device; and
a controlling unit configured to control said updating unit to execute the update processing in the second mode if an image is being displayed by said displaying unit of the digital broadcast receiving apparatus, and to execute the update processing in the first mode if an image is not being displayed by said displaying unit.

2. The apparatus according to claim 1,
wherein in the second mode, the electronic device compares a version of the program held in the digital broadcast receiving apparatus and a version of the existing program of the electronic device, and the update processing is executed if the version of the program held in the digital broadcast receiving apparatus is newer than the version of the existing program of the electronic device.

3. The apparatus according to claim 1,
wherein in the first mode, the digital broadcast receiving apparatus compares a version of the program held in the digital broadcast receiving apparatus and a version of the existing program of the electronic device, and the update processing is executed if the version of the program held in the digital broadcast receiving apparatus is newer than the version of the existing program of the electronic device.

4. The apparatus according to claim 1,
wherein a plurality of electronic devices are connected to the digital broadcast receiving apparatus, and
the update processing for performing updating with an acquired program is performed for each electronic device.

5. A digital broadcast receiving apparatus to which an electronic device lacking a function for receiving a digital broadcast signal can be connected, and that acquires a program that is distributed by being multiplexed in the digital broadcast signal and that runs on the electronic device, the apparatus comprising:
an acquiring unit configured to acquire information regarding the electronic device from the electronic device;
an extracting unit configured to extract, from notice information included in the digital broadcast signal, distribution schedule information pertaining to the program that is distributed along with the digital broadcast signal;
a schedule creating unit configured to create a schedule for executing processing for acquiring the program and processing for updating an existing program in the electronic device with the acquired program, based on the information regarding the electronic device and the program distribution schedule information; and
a displaying unit configured to display the created schedule.

6. The apparatus according to claim 5,
wherein said schedule creating unit creates the schedule such that transferring of the acquired program and/or update processing does not overlap among a plurality of electronic devices.

7. The apparatus according to claim 5,
wherein in creating the schedule, said schedule creating unit sets a priority order for the information regarding the electronic device and the program distribution schedule information.

8. The apparatus according to claim 5,
wherein if the information regarding the electronic device or the program distribution schedule information has changed, said schedule creating unit recreates the schedule based on the changed information.

9. The apparatus according to claim 7,
wherein if an amount of time required for acquiring the program and transferring the acquired program to the electronic device and/or performing updating cannot be ensured, said schedule creating unit changes the priority order and recreates the schedule based on the changed information.

10. The apparatus according to claim 5,
wherein if acquisition of the program or processing for updating with use of the acquired program in accordance with the created schedule fails, said schedule creating unit changes the schedule.

11. The apparatus according to claim 5, further comprising:
a holding unit configured to hold the acquired program,
wherein if processing for updating with use of the program acquired in accordance with the created schedule is successful, said holding unit deletes the program, and
if processing for updating with use of the acquired program has failed, said holding unit continues to hold the program instead of deleting the program.

12. The apparatus according to claim 5,
wherein the distribution schedule information includes acquisition start time information and an urgency pertaining to the program.

13. A control method for a digital broadcast receiving apparatus to which an electronic device lacking a function for receiving a digital broadcast signal can be connected, and that acquires a program that is distributed by being multiplexed in the digital broadcast signal and that runs on the electronic device, the control method comprising the steps of:
receiving the digital broadcast signal;
extracting, from the digital broadcast signal, distribution schedule information pertaining to the program that is distributed along with the digital broadcast signal;
holding the program acquired in accordance with the distribution schedule information;
displaying an image using a received image signal;
executing update processing for updating an existing program in the electronic device with the acquired program, the update processing including a first mode in which an update processing screen is displayed in said displaying step and a second mode in which an update processing screen is displayed on a display unit of the electronic device; and
performing control so that in the updating step, the update processing is executed in the second mode if an image is being displayed in said displaying step, and the update processing is executed in the first mode if an image is not being displayed in said displaying step.

14. A control method for a digital broadcast receiving apparatus to which an electronic device lacking a function for receiving a digital broadcast signal can be connected, and that acquires a program that is distributed by being multiplexed in the digital broadcast signal and that runs on the electronic device, the control method comprising the steps of:
acquiring information regarding the electronic device from the electronic device;
extracting, from notice information included in the digital broadcast signal, distribution schedule information pertaining to the program that is distributed along with the digital broadcast signal;
creating a schedule for executing processing for acquiring the program and processing for updating an existing program in the electronic device with the acquired program, based on the information regarding the electronic device and the program distribution schedule information; and
displaying the created schedule.

15. A program for causing a computer to execute the control method according to claim 13.

16. A program for causing a computer to execute the control method according to claim 14.
